(19) United States
(12) Patent Application Publication
(10) Pub. No.: US 2021/0181689 A1
(43) Pub. Date: Jun. 17, 2021

(54) MOBILE DEVICE TIMER SYSTEM

(71) Applicant: Jared Kondratuk, Henniker, NH (US)

(72) Inventor: Jared Kondratuk, Henniker, NH (US)

(21) Appl. No.: 16/986,205

(22) Filed: Aug. 5, 2020

Related U.S. Application Data
(60) Provisional application No. 62/948,949, filed on Dec. 17, 2019.

(51) Int. Cl. G04F 1/00; G05B 19/042; G06F 3/0482

(52) U.S. Cl. CPC G04F 1/005; G06F 3/0482; G05B 19/0423

(57) ABSTRACT

Methods, systems, and computer readable media for programming a timer are described. Some implementations can include a smartphone application to program a timer and/or display graphically a program that is active on the timer. Some implementations include a method for remotely programing a timer using a smartphone. In some implementations, a system to program a timer remotely includes a Bluetooth communications chip and an associated micro-controller to communicate with a smartphone application. In some implementations, a user can create a timer program sequence or timing schedule remotely and transfer the program sequence or the timing schedule to a timer from within the Bluetooth range of the timer or through a wireless network.

### RELATED APPLICATIONS

This application claims the benefit of U.S. Application No. 62/948,949, entitled “Improved Plug In and Wall Mounted Timer User Interface,” and filed on Dec. 17, 2019, which is incorporated herein by reference in its entirety.

### FIELD

Some implementations relate generally to a timer, and more particularly, to a mobile device timer system including a mobile device-based user interface for a plug-in or wall mounted timer.

### BACKGROUND

Currently available plug in or wall mounted electrical timers may typically be difficult to program. Examples of such timers include timers used on lamps and other electrical devices. The difficulty may be attributed to limited/small display space available on such timers and/or limited or few buttons available on such timers to program timing schedules by inputting desired values. Also, once a timing schedule has been programmed, the programmed data is difficult to verify.

Conventional timers may require cryptic sequences of button presses to set/change time and/or to enter timing programs due to the above-mentioned limitations of a timer interface. For example, a user may be asked to press a button “A” four times until a certain character on the screen flashes and is then asked to press button “B” once, and thereafter press the “Enter” button. Some of the conventional timers appear to have displays with characters so small that a user may need a magnifying glass simply to read characters on the display or the characters on the buttons.

It may be desirable to provide a mobile device timer system including a mobile device-based user interface for a plug-in and/or wall mounted timer or a timer application of the plug-in and/or wall mounted timer hosted on a device, such that the timer or the timer application operates on the mobile device is programmable using simple and easy to understand steps.

Some implementations were conceived in light of the above-mentioned limitations, needs, or problems, among other things. The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations can include a programmable timer comprising a communications section configured to communicate with an external device, wherein the programmable timer is configured to receive timer program settings from the external device via a computerized graphical user interface displayed on the external device when the external device is executing a mobile device-based time programming application to program the programmable timer, a data storage to store timer program settings data, and a controller coupled to the communications section and the data storage, wherein the controller is configured to execute instructions to perform programmable timer operations.

In some implementations, the computerized graphical user interface includes one or more elements to set at least one on time or at least one off time for the programmable timer. In some implementations, the computerized graphical user interface includes an interview display and input sequence to obtain timer program data from a user.

In some implementations, the computerized graphical user interface provides a visual confirmation of the timer program settings data. In some implementations, the programmable timer is remotely programmed by a third party via the communications section. In some implementations, the timer program settings are retrieved from a stored program stored in the data storage.

In some implementations, a first set of timer program settings can be used to generate a second set of timer program settings that are a clone of the first set of timer program settings. In some implementations, the communications section is configured to communicate via one or more of Bluetooth, Wi-Fi, or near field communication protocols. In some implementations, the external device is one of a mobile phone, a smartphone, a tablet computer, a laptop computer, a television, a digital camera, or a watch.

Some implementations can include a method to control a programmable timer, the method comprising: receiving communications at the programmable timer from an external device, including receiving timer program settings from the external device via a computerized graphical user interface displayed on the external device when the external device is executing a mobile device-based time programming application, storing the timer program settings data, and executing instructions to perform programmable timer operations based on the timer program settings data.

In some implementations, the computerized graphical user interface includes one or more elements to set at least one on time or at least one off time. In some implementations, the computerized graphical user interface includes an interview display and input sequence to obtain timer program data from a user.

In some implementations, the computerized graphical user interface provides a visual confirmation of the timer program settings data. In some implementations, the programmable timer is remotely programmed by a third party via the communications section. The method can also include retrieving timer program settings from a stored program stored in a data storage of the programmable timer.

In some implementations, a first set of timer program settings can be used to generate a second set of timer program settings that are a clone of the first set of timer program settings. In some implementations, a communications section of the programmable timer is configured to communicate via one or more of Bluetooth, Wi-Fi, or near field communication protocols.

In some implementations, the external device is one of a mobile phone, a smartphone, a tablet computer, a laptop computer, a television, a digital camera, or a watch.

Some implementations include a computerized user interface for a timer application on a computing device. In some implementations, the user interface may comprise a first selector to select one or more days of a week during which a timer is to be active; a second selector to select a first start time of the one or more days of the week at which the timer is to be turned on and a first end time of the one or more days of the week at which the timer is to be turned off; and a user interface element to submit a first selection corresponding to the first selector and a second selection corresponding to the second selector, wherein the second selection comprises a start time selection for turning on the timer and an end time selection for turning off the timer.

In some implementations, the user interface can include a third selector to program a second start time for turning on the timer and a second end time for turning off the timer during the one or more days of the week. In some other implementations, the user interface can include a third selector to program a second start time for turning on the timer and a second end time for turning off the timer during a new selection of one or more new days of the week different from the one or more days of the week. In some implementations, the user interface can also include a fourth selector to select all days of the week as the one or more days of the week. In some other implementations, the user interface can further include a fifth selector to select one or more days of one or more of a month or a year during which the timer is to be active.

In some implementations of the user interface, the start time and the end time include hour, minute, and second values. In some implementations of the user interface, the computing device is one of a mobile phone, a smartphone, a tablet computer, a laptop computer, a television, a digital camera, or a watch.

In some implementations, a computerized method for programming a timer using an application on a computing device comprises selecting one or more days of a week during which the timer is to be active; selecting a first start time of the one or more days of the week at which the timer is to be turned on and a first end time of the one or more days of the week at which the timer is to be turned off; and submitting a first selection of the one or more days of the week and a second selection comprising a start time selection for turning on the timer and an end time selection for turning off the timer.

In some implementations, the method can include selecting a second start time for turning on the timer and a second end time for turning off the timer during the one or more days of the week. In some other implementations, the method can include selecting a second start time for turning on the timer and a second end time for turning off the timer during a new selection of one or more new days of the week different from the one or more days of the week. In some implementations, the method can include selecting one or more days of one or more of a month or a year during which the timer is to be active. In some implementations, the start time and the end time mentioned in the abovementioned method include hour, minute, and second values.

Some implementations include a system for programming a timer. In some of the implementations, the system includes one or more processors and a non-transitory computer readable storage having software instructions stored thereon configured to cause the one or more processors to select one or more days of a week during which the timer is to be active; select a first start time of the one or more days of the week at which the timer is to be turned on and a first end time of the one or more days of the week at which the timer is to be turned off; and submit a first selection of the one or more days of the week and a second selection comprising a start time selection for turning on the timer and an end time selection for turning off the timer.

Some implementations of the system may include a user interface displayed on a screen to facilitate the programming of the timer. In some implementations, the one or more processors of the system may select a second start time for turning on the timer and a second end time for turning off the timer during the one or more days of the week. In some other implementations, the one or more processors of the system may select a second start time for turning on the timer and a second end time for turning off the timer during a new selection of one or more new days of the week different from the one or more days of the week. In some implementations, the one or more processors of the system further select one or more days of one or more of a month or a year during which the timer is to be active.

In some implementations of the system, the one or more processors of the system further select one or more days of one or more of a month or a year during which the timer is to be active. In some implementations, the one or more processors of the system are part of one of a mobile phone, a smartphone, a tablet computer, a laptop computer, a television, a digital camera, or a watch. In some implementations of the system comprising a user interface displayed on a screen to facilitate the programming of the timer, the screen may include one of a building display screen, a window display screen, an appliance display screen, a furniture display screen, a product display screen, a vehicle window display screen, a vehicle windshield display screen, a vehicle interior display screen, a backlit display screen, a non-backlit display screen, an LCD screen, an LED screen, or an OLED display screen.

### BRIEF DESCRIPTION OF THE DRAWINGS

FIG. 1 is a diagram of an exemplary timer user interface on an exemplary smartphone application in accordance with some implementations.

FIG. 2 is a diagram of an example display of a typical user interface of a conventional timer in accordance with some implementations.

FIG. 3 is a diagram of a typical user interface of an example conventional timer in accordance with some implementations.

FIG. 4 is a diagram of a typical user interface of an example conventional timer in accordance with some implementations.

### DETAILED DESCRIPTION

In some implementations, a timer user interface utilizes smartphone displays and/or user interfaces of the corresponding smartphones. As users are familiar with user interfaces of their respective smart phones, these smartphone timer user interfaces are generally user-friendly. Examples of smartphone displays and user interfaces are touch screen displays that may change according to the context. Some implementations use a combination of buttons, sliders and/or keyboards to input the data required to program a timer while providing a user-friendly interface.

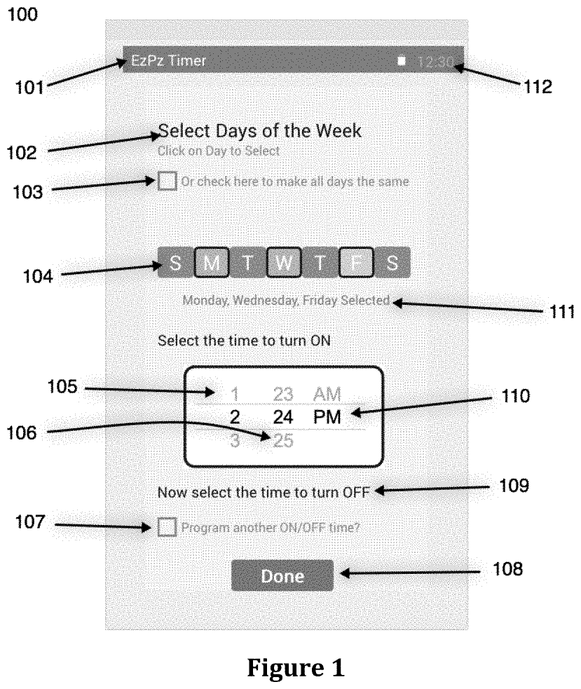

FIG. 1 is a diagram of an exemplary timer user interface on an example smartphone in accordance with some implementations. More specifically, FIG. 1 shows an example embodiment of a timer user interface 100 on a smartphone. The user interface of this embodiment is easy to understand, thus allowing a user to set up the timer ON and OFF times easily. A navigation bar includes the name 101 of a timer application (e.g., EzPz Timer) on the upper left side and the current time 112 on the upper right side. The instruction 102 directs a user to “Select Days of the Week” and a selector 103 allows the user to choose to “make all days the same”. The days of the week can be specified using a selector 104—the selected day is highlighted by darkening the background of the letter corresponding to the selected day. The selected days are displayed at 111 (directly below the selector 104). The hour of the day is selected at 105, the minutes of the hour are selected at 106, and the AM/PM selection is provided at 110. Another instruction directs the user to “Select the time to turn ON” while the instruction 109 directs the user to “select the time to turn OFF”—both of which are performed using selectors 105, 106, 110. The instruction 107 directs the user to “Program another ON/OFF time”. The user selects “Done” at 108 to confirm and submit the data. In some implementations, above steps may be repeated a number of times.

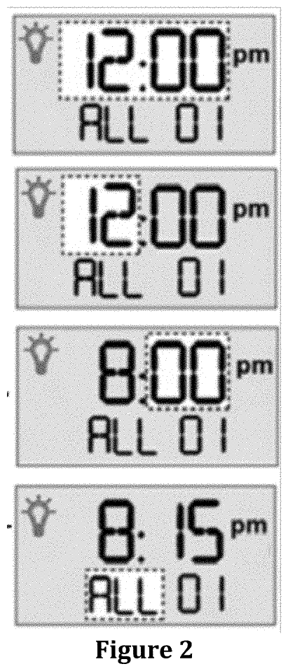

FIG. 2 is a diagram of an example display of a typical user interface of a conventional timer in accordance with some implementations. More specifically, FIG. 2 shows a typical user interface of a conventional timer setup screen with instructions to appreciate the difficulty of following the instructions on the user interface, which difficulty is known in the industry. FIG. 2 helps understand some of the advantages of user interface 100 over the user interface of FIG. 2.

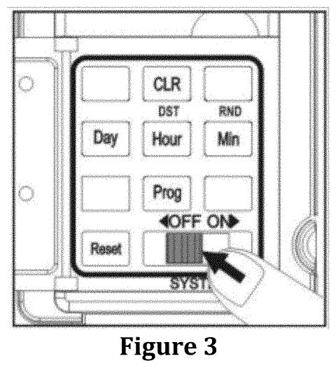

FIG. 3 is a diagram of a typical user interface of an example conventional timer in accordance with some implementations. More specifically, FIG. 3 shows a typical user interface of a conventional timer to appreciate the small size and the difficulty of using the interface. FIG. 3 helps understand some of the advantages of user interface 100 over the user interface of FIG. 3.

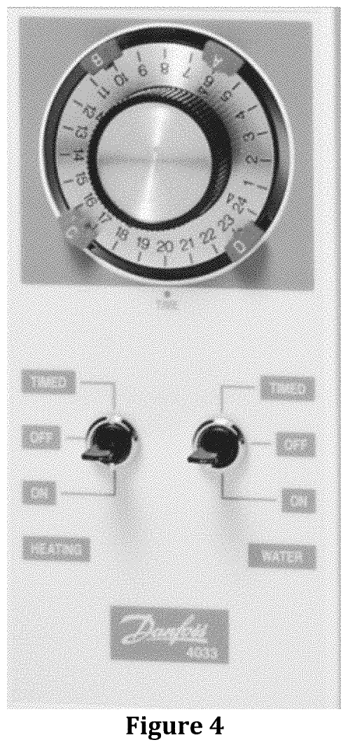

FIG. 4 is a diagram of a typical user interface of an example conventional timer in accordance with some implementations. More specifically, FIG. 4 shows another embodiment of a conventional timer user interface, where the interface comprises mechanical switches and tabs that are arranged on the outer diameter of a wheel denoting 24 hours in a day. The accuracy of timing using this type of timer interface is closer to an hour than to a minute and is therefore suitable for general purposes such as turning Christmas tree lights ON or OFF. The disclosed embodiment, on the other hand, has a timing accuracy to the minute as shown in FIG. 1. FIG. 4 helps understand some of the advantages of user interface 100 over the user interface of FIG. 4.

Smartphone displays allow for virtually any type of user interface, thereby making such displays user friendly to host timer user interfaces and timer applications. Smartphone displays are typically, for the most part, and sometimes, entirely, touch screen displays that can change according to the context. Also, smartphones provide user-friendly interfaces for inputting the data required to program a timer through a combination of buttons, sliders, and/or keyboards.

In some implementations, the features of smartphones are used to make programming of a timer simple, easy, and/or intuitive. As the information displayed on a smartphone is generally context derived, an easy to understand and easy to use timer programming application can be designed for a smartphone. Smartphone displays can be easy to view (e.g., data being entered and data previously entered into the timer) and easy to enter data and can make entering of a timer schedule easy even for a non-technical user, who is not used to typical timer interfaces.

A timer user interface may use graphical images, letters, numbers, symbols, etc. In general, any graphical image or alphanumeric image can be used on the timer interface. The timer interface can be hosted on the screens of devices such as mobile phones, tablet computers, laptop computers, smartphones, digital cameras, televisions, watches, etc., as well as display screens on buildings, windows, appliances, furniture, products, etc. Timer interfaces can also be hosted on vehicle window or windshield displays or on a vehicle interior display screen. The timer interfaces can be hosted on any backlit display or non-backlit (e.g., OLED) display screen.

In some implementations, the timer user interface can be provided through a smartphone application or “App”. Applications or “Apps” run on smartphones and can enable user-friendly interactions. An App can be designed with clear and easy to understand graphics and symbols and can be made intuitive to operate. Such Apps are not limited to only a few physical buttons since Apps can offer virtually any combination of buttons, switches, keyboards, and sliders on touch screen displays. This translates into convenient options for programming a timer operation and times that are being programmed are visible on the display during a programming operation.

Also, an App can show when a timer is being programmed to be ON and OFF on a given day, week, or an even longer period (e.g., month or year). Apps can be designed such that a user can tap and swipe items on the display to enter or change timer data and options. For example, if the user notices (on the display) that the timer has been programmed to turn ON at 4:30 and the user wants to change the ON time to 4:17, all the user may have to do is drag an icon to 4:17.

In some implementations, the exemplary timer is not connected to a home network over Wi-Fi or similar technology. In some other implementations, the exemplary timer is connected to a home network and a timer application hosted on a smartphone, laptop, or desktop computer is connected via the home network to the exemplary timer on the corresponding device (e.g., lamp). For example, several home automation devices allow the control and timing of electrical outlets via a network. In some implementations, for a network connected device, there is no need to have a timer at the device since the network controller can perform the timing function(s).

In some implementations, the timer is a stand-alone, wall mounted, or plug in timer that can be programmed using a smartphone application. In some implementations, an exemplary device does not have a Wi-Fi interface but instead uses a Bluetooth interface to connect to the timing application on the smartphone. As most of today's smartphones have built-in Bluetooth technology, a Wi-Fi interface may not be required. In some implementations, the exemplary device has a Wi-Fi interface to connect to smartphones (especially, to connect to smartphones without Bluetooth functionality). In some implementations, an exemplary device has both Wi-Fi and Bluetooth interfaces to enable connection to a smartphone via either Wi-Fi or Bluetooth.

In some implementations, the initial connection or “pairing” of a timer to a smartphone is designed so that the operation is easy and intuitive to perform. For example, a program on the smartphone may guide a user through the “pairing” process step by step. The “pairing” process does not take more than one minute to complete the setup in some implementations. During the initial process, a user-friendly name may be assigned to that timer in order to store the settings.

In some implementations, a user needs to first pair a timer with a smartphone in order to program the timer. In some implementations, this is a simple one-time process that can take less than a minute. During this pairing, the user may be able to assign a meaningful name to the timer being programmed (e.g., “living room timer” or “living room lights timer”)—in practice, the user can assign any desired name to the timer. Upon assigning a name to a timer, thereafter, the timer is identified by the given name. In order to program a timer that has been assigned a name, the user opens the smartphone timing application and selects the timer to program. The user can thereafter select a timer and view an existing timer program and/or other timer settings, modify any of the timer settings, programs, or schedules, and re-save or resubmit a new timing schedule.

In some implementations, the exemplary timing application on a smartphone can be used to program existing portable, wall mounted timers, and plug-in timers available in the market. These timers may be available in a wide variety of styles, sizes, capabilities, and prices. However, they all incorporate some type of a micro-controller that can be adapted to include a Bluetooth interface as Bluetooth is one of the most common interfaces used to communicate between devices. Also, most smartphones are Bluetooth enabled. As users will most likely program a timer in proximity to the device hosting the timer, Bluetooth transmission distance is not usually an issue in such applications. Moreover, users need to be in close proximity to the timer not only to program but also verify that the timed appliance turns ON and OFF correctly.

In some implementations, a timer user interface may include time increments that include seconds as well as days and weeks. As mentioned previously, either Bluetooth or Wi-Fi may be used to provide communication between the smartphone (timing application) and the timer. In some implementations, an email server is used to program a timer remotely as well as remotely turn the timer ON or OFF. In some implementations, the elements of a timer may have external input capability, such as an external switch to turn the timer ON or OFF, as well as the ability to configure or select the ON or OFF timer command remotely using, for example, a smartphone application. For example, moisture detectors may need to remotely turn ON/OFF a water valve.

Some implementations include a programming option for a user to setup a timer or one or more elements of a timer and/or to program the timer on a website and/or a program using one or more of a desktop or a laptop computer. A desktop or a laptop computer provides a larger screen compared to a smartphone screen to setup and/or verify a timer program and/or timing schedule. In some implementations, a user has the ability to download a new timing program or schedule to the user's smartphone and then use Bluetooth or Wi-Fi to transfer the program or schedule to the timer. Such downloads may be automated in some implementations so that the same timing program or schedule appears on the smartphone timing application. In some implementations, a user who needs help to set up a timing program or schedule can contact one or more technical support personnel to help the user with the timing setup by viewing the user's timing application. The support personnel can, in some implementations, also set up the timing program/schedule for the user and/or automatically download the timing program on to the user's smartphone.

In some implementations, timer applications encompass the irrigation timing industry, Christmas tree lighting timing, timing for ventilators, fans, and air-conditioners, and timing for medical support systems (such as ventilators, humidifiers, and the like) and veterinary timing installations. In some implementations, timer applications may be integrated with wireless and Bluetooth facilities, such that the connected devices are controlled using the timing application.

Even though home automation is becoming popular, not all homes are equipped with home automation electronics today. In 2017, less than 15% of US homes were installed with automation systems. And even though home automation systems can be powerful and control virtually every system in a home, they can be an expensive solution for the user who wants to only control a few lights or other electronic devices and not the entire home. Plugin and wall mounted timers are available both on the Internet and from many hardware and home-centers and enable the user to only control a few lights and/or other electronic devices of their choice.

It is, therefore, readily apparent that there is provided, in accordance with the various implementations disclosed herein, a user interface for a timer, wherein the user interface can be hosted on a smartphone, for example, a smartphone application, or on any other display screen.

In general, a computer that performs the processes described herein can include one or more processors and a memory (e.g., a non-transitory computer readable medium). The process data and instructions may be stored in the memory. These processes and instructions may also be stored on a storage medium such as a hard drive (HDD) or a portable storage medium or may be stored remotely. Note that each of the functions of the described embodiments may be implemented by one or more processors or processing circuits or processor circuitry.

A processing circuit can include a programmed processor, as a processor includes circuitry. A processing circuit/circuitry may also include devices such as an application specific integrated circuit (ASIC) and conventional circuit components arranged to perform the recited functions. The processing circuitry can be referred to interchangeably as circuitry throughout the disclosure. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk, or any other information processing device. The processor may contain one or more processors and may even be implemented using one or more heterogeneous processor systems.

According to certain implementations, the instruction set architecture of the processor can use a reduced instruction set architecture, a complex instruction set architecture, a vector processor architecture, and/or a very large instruction word architecture. Furthermore, the processor can be based on the Von Neumann model or the Harvard model. The processor can be a digital signal processor, an FPGA, an ASIC, a PLA, a PLD, or a CPLD. Further, the processor can be an x86 processor by Intel or by AMD, an ARM processor, a Power architecture processor by, e.g., IBM, a SPARC architecture processor by Sun Microsystems or by Oracle; or any other known CPU architecture.

The functions and features described herein may also be executed by various distributed components of a system. For example, one or more processors may execute the functions/features, wherein the processors are distributed across multiple components communicating in a network. The distributed components may include one or more client and server machines, which may share processing in addition to sharing various human interface and communication devices (e.g., display monitors, smart phones, tablets, personal digital assistants (PDAs)). The network may be a private network, such as a LAN or WAN, or may be a public network, such as the Internet. Input to the system may be received via direct user input or received remotely either in real-time or as a batch process. Additionally, some implementations may be performed on modules or hardware not identical to those described. Accordingly, other implementations are within the scope that may be claimed.

It is contemplated that any optional feature of a described implementation may be set forth and claimed independently and/or in combination with any one or more of the features described herein. Reference to a singular item includes the possibility that there is a plurality of the same items present in one or more implementations. More specifically, as used herein and in the claims, singular forms “a,” “an,” “said,” and “the” include plural referents unless specifically stated otherwise. In other words, use of the articles allow for “at least one” of the subject item in the description above as well as the claims below. It is further noted that additional claims may be drafted to exclude any optional element. As such, this statement is intended to serve only as an antecedent basis for the use of such exclusive terminology as “solely,” “only,” and the like in connection with the recitation of claim elements or use of a “negative” limitation. Without use of such exclusive terminology, the term “comprising” in the claims shall allow for the inclusion of any additional element, irrespective of whether a given number of elements are enumerated in the claims or whether addition of a feature could be regarded as transforming the nature of an element set forth in the claims. Except as specifically defined herein, all technical and scientific terms used herein are to be given as broad a commonly understood meaning as possible while maintaining the validity of the claims.

The breadth of the disclosed invention is not to be limited to the examples provided and/or the subject specification. Use of the term “invention” herein is not intended to limit the scope of the claims in any manner. Rather, it should be recognized that the “invention” includes the variations explicitly or implicitly described herein, including those variations that would be obvious to one of ordinary skill in the art upon reading the present specification. Further, it is not intended that any section of this specification (e.g., Summary, Detailed Description, Abstract, Field of the Invention, etc.) be accorded special significance in describing the invention relative to each other or to the claims. All references cited are incorporated by reference in their entirety. Although the foregoing invention has been described in detail for the purposes of clarity of understanding, it is contemplated that modifications may be practiced within the claimed scope.

A number of implementations have been described. While the disclosed subject matter has been described in conjunction with a number of embodiments, it is evident and will be understood that many alternatives, various modifications, and several variations may be, would be, or are, apparent to those of ordinary skill in the applicable arts. Such alternatives, variations, and modifications may be made without departing from the spirit and scope of this disclosure. Accordingly, Applicant intends to embrace all such alternatives, modifications, equivalents, and variations that are within the spirit and scope of the disclosed subject matter.

For example, preferable results may be achieved if the steps of the disclosed invention were performed in a different sequence, if components in the disclosed systems were combined in a different manner, or if the components were replaced or supplemented by other components. The functions, processes, and algorithms described herein may be performed in hardware and/or software executed by hardware, including computer processors and/or programmable circuits configured to execute program code and/or computer instructions to execute the functions, processes, and algorithms described herein. Additionally, an implementation may be performed on modules or hardware not identical to those described. Accordingly, other implementations are within the scope that may be claimed.

What is claimed is:

1. A programmable timer comprising:
a communications section configured to communicate with an external device, wherein the programmable timer is configured to receive timer program settings from the external device via a computerized graphical user interface displayed on the external device when the external device is executing a mobile device-based time programming application to program the programmable timer,
a data storage to store timer program settings data; and
a controller coupled to the communications section and the data storage, wherein the controller is configured to execute instructions to perform programmable timer operations.

2. The programmable timer of claim 1, wherein the computerized graphical user interface includes one or more elements to set at least one on time or at least one off time for the programmable timer.

3. The programmable timer of claim 1, wherein the computerized graphical user interface includes an interview display and input sequence to obtain timer program data from a user.

4. The programmable timer of claim 1, wherein the computerized graphical user interface provides a visual confirmation of the timer program settings data.

5. The programmable timer of claim 1, wherein the programmable timer is remotely programmed by a third party via the communications section.

6. The programmable timer of claim 1, wherein the timer program settings are retrieved from a stored program stored in the data storage.

7. The programmable timer of claim 1, wherein a first set of timer program settings can be used to generate a second set of timer program settings that are a clone of the first set of timer program settings.

8. The programmable timer of claim 1, wherein the communications section is configured to communicate via one or more of Bluetooth, Wi-Fi, or near field communication protocols.

9. The programmable timer of claim 1, wherein the external device is one of a mobile phone, a smartphone, a tablet computer, a laptop computer, a television, a digital camera, or a watch.

10. A method to control a programmable timer, the method comprising:
receiving communications at the programmable timer from an external device, including receiving timer program settings from the external device via a computerized graphical user interface displayed on the external device when the external device is executing a mobile device-based time programming application;
storing the timer program settings; and
executing instructions to perform programmable timer operations based on the timer program settings data.

11. The method of claim 10, wherein the computerized graphical user interface includes one or more elements to set at least one on time or at least one off time.

12. The method of claim 10, wherein the computerized graphical user interface includes an interview display and input sequence to obtain timer program data from a user.

13. The method of claim 10, wherein the computerized graphical user interface provides a visual confirmation of the timer program settings data.

14. The method of claim 10, wherein the programmable timer is remotely programmed by a third party via communications.

15. The method of claim 10, further comprising retrieving timer program settings from a stored program stored in a data storage of the programmable timer.

16. The method of claim 10, wherein a first set of timer program settings can be used to generate a second set of timer program settings that are a clone of the first set of timer program settings.

17. The method of claim 10, wherein a communications section of the programmable timer is configured to communicate via one or more of Bluetooth, Wi-Fi, or near field communication protocols.

18. The method of claim 10, wherein the external device is one of a mobile phone, a smartphone, a tablet computer, a laptop computer, a television, a digital camera, or a watch.
